(19) United States
(12) Patent Application Publication
(10) Pub. No.: US 2010/0313136 A1
(43) Pub. Date: Dec. 9, 2010

(54) MENU SCREEN DISPLAY CONTROL APPARATUS AND MENU SCREEN DISPLAY CONTROL METHOD

(75) Inventors: Junichi YOSHIZAWA, Fuchu-shi (JP); Hideo KATAOKA, Tokyo (JP); Takayasu TSUCHIUCHI, Sagamihara-shi (JP); Dai ISHIMARU, Koganei-shi (JP); Yoshimasa OKUBO, Ome-shi (JP); Kazuhide SAWA, Ome-shi (JP); Yoshito YAMADA, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/797,563

(22) Filed: Jun. 9, 2010

(30) Foreign Application Priority Data
Jun. 9, 2009 (JP) 2009-138552

(51) Int. Cl. G06F 3/048; G06F 15/16

(52) U.S. Cl. 715/739; 715/835; 709/219

(57) ABSTRACT

According to one embodiment, a display control apparatus includes a memory, an output module, and a setting module. The memory is configured to store first menu configuration information to compose a first menu screen and second menu configuration information to compose a second menu screen. The output module is configured to output first menu screen display information to display the first menu screen based on the first menu configuration information and content data in response to a selection operation of the first menu screen, and to output second menu screen display information to display the second menu screen based on the second menu configuration information and content data in response to a selection operation of the second menu screen. The setting module is configured to set one of the first menu screen and the second menu screen as a top menu displayed at a startup timing.

### CROSS-REFERENCE TO RELATED APPLICATIONS

This application is based upon and claims the benefit of priority from Japanese Patent Application No. 2009-138552, filed Jun. 9, 2009; the entire contents of which are incorporated herein by reference.

### FIELD

Embodiments described herein relate generally to a menu screen display control apparatus and menu screen display control method, which control to selectively display two menu screens.

### BACKGROUND

In recent years, an audio/video processing apparatus can execute more complex processes. Practical factors of such ability include advent of high-performance central processing units (CPUs) and advanced operating systems (OSs). As their subsidiary effects, a more advanced application run-time environment can be built. This is because, for example, a run-time environment of sequentially interpreted codes in place of platform-native instruction codes is implemented on the OS. Furthermore, the aforementioned more advanced application run-time environment abstracts OS differences to present as if one instruction set were being executed on various OSs.

For example, a widget which runs in an application run-time environment built by an audio/video processing apparatus is known. For example, the widget is a simple application, and includes XML data and scripting code. The widget is accessible to the Internet, and has graphical user interface (GUI) elements. As a technique associated with the widget, a Widget Platform to run the widget is known. The Widget Platform can be installed not only in a personal computer but also in a video device such as a television or DVD player. Thus, advanced processing of applications using the Widget Platform and widgets can be provided not only to the users of personal computers but also to various users.

For example, one video device can play Compact Disc (CD) content, DVD content, and SD content using widgets. Using a resume function, for example, after the video device stops (or pauses) playback of CD content, and plays back DVD content and stops playback of the DVD content, it can resume playback from the playback stop position (or playback pause position) of the CD content. In this way, the user can selectively enjoy content of media using the video device. Furthermore, such video device allows the user to view content and can provide a shopping environment via the Internet using widgets.

When a single video device allows the user to view miscellaneous content and to receive various services using widgets, the improvement of menu screens displayed on the video device is requested.

For example, Jpn. Pat. Appln. KOKAI Publication No. 2001-188672 (reference 1) discloses a launcher menu display system, which displays a launcher menu on a desktop screen, and establishes connection to the Web or launches an application, which corresponds to a link icon selected from link icons displayed in the launcher menu. Thus, link destinations can be connected from the launcher menu.

However, according to the technique disclosed in reference 1 above, a large number of icons are eventually displayed within one menu screen, resulting in poor visibility of respective icons.

For example, when an icon to establish connection to a site of a content provider is displayed on the menu screen by receiving an advertisement charge from the content provider, if that icon has poor visibility, a sufficient advertisement charge cannot be received. Then, an icon having a relatively large size has to be displayed on the menu screen. However, when the icon size is increased, the number of icons that can be displayed on the menu screen is limited, and a large number of applications cannot be selected in turn.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary schematic block diagram showing the arrangement of an audio/video processing apparatus (information playback apparatus) according to one embodiment;

FIG. 2 is a view showing an example of a start menu screen; and

FIG. 3 is a view showing an example of a channel menu screen.

### DETAILED DESCRIPTION

Various embodiments will be described hereinafter with reference to the accompanying drawings.

In general, according to one embodiment, a display control apparatus includes a memory, an output module, and a setting module. The memory is configured to store first menu configuration information to compose a first menu screen and second menu configuration information to compose a second menu screen. The output module is configured to output first menu screen display information to display the first menu screen based on the first menu configuration information and content data in response to a selection operation of the first menu screen, and to output second menu screen display information to display the second menu screen based on the second menu configuration information and content data in response to a selection operation of the second menu screen. The setting module is configured to set one of the first menu screen and the second menu screen as a top menu displayed at a startup timing. The first menu screen is configured to include playback application items used to individually launch playback applications corresponding to content sources, and the second menu screen is configured to include network application items used to individually launch network applications corresponding to network services.

Embodiments will be described hereinafter with reference to the drawings.

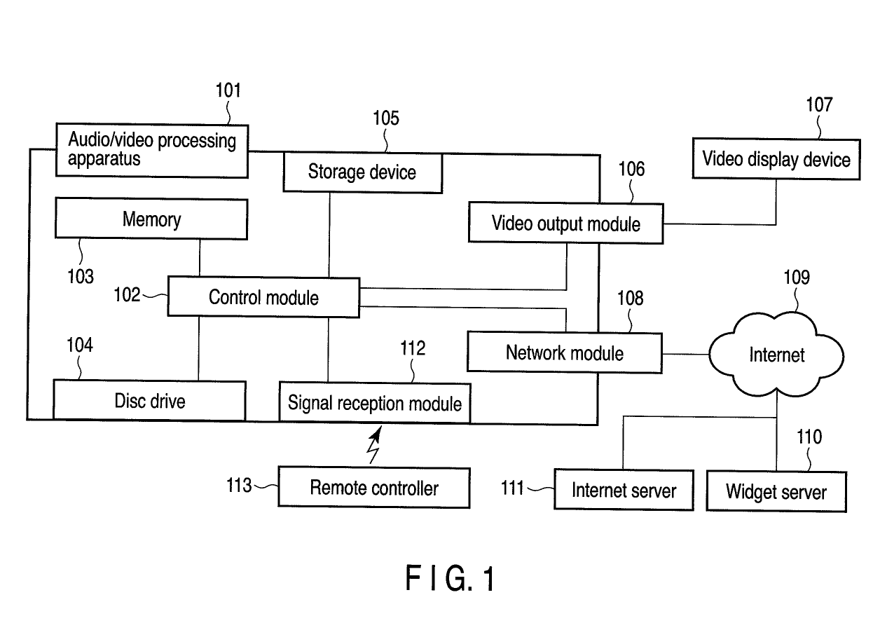

FIG. 1 is a schematic block diagram showing the arrangement of an audio/video processing apparatus (menu screen display control apparatus) according to one embodiment. As shown in FIG. 1, an audio/video processing apparatus 101 includes a control module 102, memory 103, disc drive 104, storage device 105, video output module 106, network module 108, and signal reception module 112.

The disc drive 104 can read content data recorded on discs such as a CD and DVD. The storage device 105 includes a hard disc, flash drive interface, and memory card interface. The hard disc stores multimedia files (content data) such as MP3 files and wmv files, and also various application data. The flash drive interface can read multimedia files (content data) stored in a flash drive. The memory card interface can read multimedia files (content data) stored in a memory card.

The control module 102 can play back, based on a multimedia file playback application, multimedia files in the DVD, CD, hard disc, flash drive, and memory card.

The network module 108 can download various data from an Internet server 111 and widget server 110 via an Internet 109. The downloaded data are stored on, e.g., the hard disc of the storage device 105.

The signal reception module 112 receives a control signal from, e.g., a remote controller 113, and notifies the control module 102 of the control signal. The control module 102 controls various operations based on control signals notified from the signal reception module 112. For example, the control module 102 controls playback of the content of, e.g., a CD or DVD based on a playback control signal of the content of, e.g., the CD or DVD, and also controls playback of the content in the storage device 105 based on a playback control signal of the content in the storage device 105.

The control module 102 includes a Widget Platform to run widgets, and controls these widgets. Also, the control module 102 controls display of a video display device 107. That is, the video output module 106 outputs display information to the video display device 107 under the display control of the control module 102, and the video display device 107 displays a display image based on the display information.

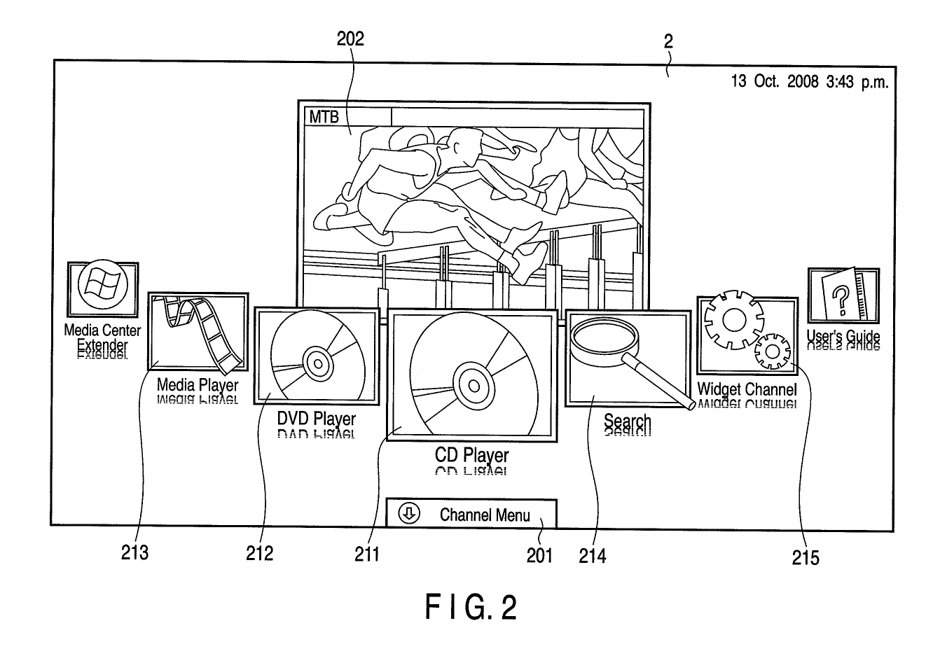

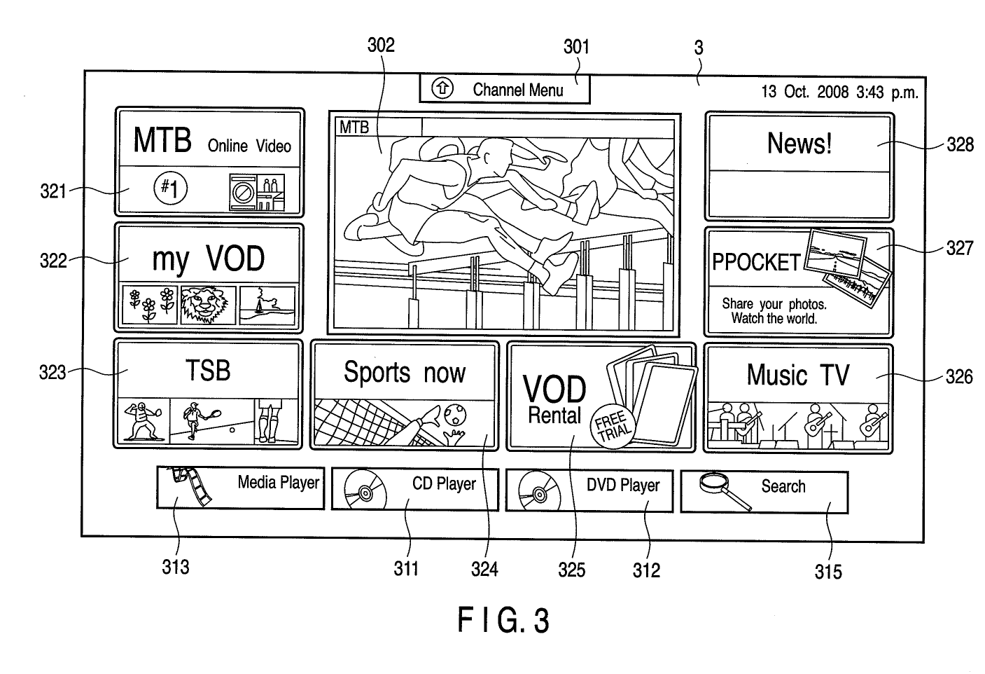

A menu screen displayed on the video display device 107 will be described below. The audio/video processing apparatus can selectively display a start menu screen and channel menu screen, so as to allow to select a large number of applications with high visibility. FIG. 2 is a view showing an example of the start menu screen, and FIG. 3 is a view showing an example of the channel menu screen.

The storage device 105 stores start menu configuration information used to configure a start menu screen 2, and also channel menu configuration information used to configure a channel menu screen 3. Or the memory 103 (nonvolatile memory) stores the start menu configuration information and channel menu configuration information.

The control module 102 controls output of start menu screen display information to display the start menu screen 2 based on start menu configuration information and content data (a movie, etc.) in response to a user's selection operation of the start menu screen 2. In response to this control, the video output module 106 outputs the start menu screen display information to the video display device 107. As a result, the video display device 107 displays the start menu screen 2, as shown in FIG. 2.

The control module 102 controls outputting of channel menu screen display information to display the channel menu screen 3 based on channel menu configuration information and content data (a movie, etc.) in response to a user's selection operation of the channel menu screen 3. In response to this control, the video output module 106 outputs the channel menu screen display information to the video display device 107. As a result, the video display device 107 displays the channel menu screen 3, as shown in FIG. 3.

Details of the start menu screen 2 and channel menu screen 3 will be described below. For example, a top screen, which is displayed first on the video display device 107 when electric power is supplied to the audio/video processing apparatus to start it up, is the start menu screen 2 or channel menu screen 3. For example, when the user sets the start menu screen 2 as the top screen via, e.g., the remote controller 113, the start menu screen 2 is displayed first. When the user sets the channel menu screen 3 as the top screen via, e.g., the remote controller 113, the channel menu screen 3 is displayed first. That is, each of the start menu screen 2 and channel menu screen 3 can serve as a top menu which is launched at the time of powering on, and these screens can be switched depending on a user's setting.

For example, the start menu screen 2 is configured as follows.

The start menu screen 2 includes many blank spaces, and can display impactful items (icons) by using a three-dimensional (3D) or pseudo-3D technique. For example, the start menu screen 2 includes setting items (setting icons) used to set various functions (a clock, language, display, audio output, etc.) of the audio/video processing apparatus. The start menu screen 2 includes playback application items (playback application icons) used to individually launch playback applications corresponding to content sources (CD, DVD, etc.) These setting icons and the playback application icons can be displayed to have various sizes.

For example, as shown in FIG. 2, the start menu screen 2 includes a CD Player icon 211, DVD Player icon 212, Media Player icon 213, Search icon 214, and Widget Channel icon 215. Furthermore, the selected CD Player icon 211 is displayed to have an enlarged display size. The DVD Player icon 212 as a second selection candidate (which is not selected) is displayed to have a first size smaller than the enlarged display size, and the Search icon 214 as another second selection candidate (which is not selected) is also displayed to have the first size smaller than the enlarged display size. The Media Player icon 213 as a third selection candidate (which is not selected) is displayed to have a second size smaller than the first size, and the Widget Channel icon 215 as another third selection candidate (which is not selected) is also displayed to have the second size smaller than the first size.

The start menu screen 2 includes a playback window 202 of content (e.g., a movie). The content may be either that stored in the storage device 105 or that downloaded via, e.g., the network module 108. For example, as shown in FIG. 2, the start menu screen 2 includes the content playback window 202 at the central position, and includes setting icons and playback application icons which are displayed to have various sizes around the content playback window 202.

The start menu screen 2 includes a channel menu switching item (channel menu switching icon 201) used to switch the start menu screen 2 to the channel menu screen 3.

The start menu screen 2 is configured based on start menu configuration information, which is prepared in advance. For example, the start menu screen 2 is configured based on start menu configuration information which is stored in the storage device 105 at the time of delivery of the audio/video processing apparatus.

For example, the channel menu screen 3 is configured as follows.

The channel menu screen 3 includes network application items (shortcut icons) used to individually launch network applications (widgets) corresponding to network services. These network application items have a uniform display size. For example, as shown in FIG. 3, the channel menu screen 3 includes shortcut icons 321, 322, 323, 324, 325, 326, 327, and 328.

The network application items can include advertisement information corresponding to download data downloaded from an external server. For example, assume that this advertisement information is suited to user's preference. The channel menu screen 3 includes the network application items which are laid out in a tile pattern without including many blank spaces. Because of the tile pattern layout, the network application items have high viewability.

The channel menu screen 3 includes a playback window 302 of content (e.g., a movie). The content may be either that stored in the content storage device 105 or that downloaded via, e.g., the network module 108. For example, as shown in FIG. 3, the channel menu screen 3 includes the content playback window 302 at the center, and includes the network application items displayed to have a uniform size around the content playback window 302.

The channel menu screen 3 includes playback application items (playback application icons) used to individually launch playback applications corresponding to content sources (CD, DVD, etc.). However, since the network application items are preferentially displayed, the playback application items are displayed to have a smaller size. For example, as shown in FIG. 3, the channel menu screen 3 includes a CD Player icon 311, DVD Player icon 312, Media Player icon 313, and Search icon 314. Note that these icons are those used to lay out widget sub-sections on the screen, and are also called snippets (sub-section display regions).

The channel menu screen 3 includes a start menu switching item (start menu switching icon 301) used to switch the channel menu screen 3 to the start menu screen 2.

The channel menu screen 3 is configured based on channel menu configuration information which is updated by download data downloaded from an external server. In other words, the external server can control the configuration of the channel menu screen 3. For example, the external server can freely control the layout of respective network application items.

As described above, the configuration of the start menu screen 2 and that of the channel menu screen 3 are different, and the user can select and use a preferred screen. The memory 103 (nonvolatile memory) stores the previous selection operation of those of the start menu screen 2 and channel menu screen 3, and the control module 102 outputs either one of the start menu screen display information and channel menu screen display information in correspondence with the previous selection operation stored in the memory 103 at the restart timing. That is, assume that the start menu screen 2 was selected previously, and power supply to the audio/video processing apparatus was then stopped. In this case, the start menu screen display information is output at the restart timing, and the start menu screen 2 is displayed. Or assume that the channel menu screen 3 was selected previously, and power supply to the audio/video processing apparatus was then stopped. In this case, the channel menu screen display information is output at the restart timing, and the channel menu screen is displayed.

As described above, the audio/video processing apparatus outputs display information to display a menu screen of either one of the start menu screen 2 and channel menu screen 3 in response to a user's menu selection operation. In response to this, the video display device 107 displays the menu screen of either one of the start menu screen 2 and channel menu screen 3.

For example, a manufacturer of the audio/video processing apparatus wants to receive some advertisement charge or service charge from a content provider by displaying a shortcut icon used to establish connection to a site of the content provider. For this purpose, the shortcut icon having a relatively large size has to be displayed on the menu screen. Thus, the channel menu screen 3 can display the shortcut icon having a relatively large size. Also, the types and layout of shortcut icons on the channel menu screen 3 can be controlled by the external server.

As described above, since the channel menu screen 3 displays shortcut icons each having a relatively large size, the size of each playback application icon becomes relatively small. Hence, the start menu screen 2 can display the playback application icons whose size changes according to a selection.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The various modules of the systems described herein can be implemented as software applications, hardware and/or software modules, or components on one or more computers, such as servers. While the various modules are illustrated separately, they may share some or all of the same underlying logic or code. The accompanying claims and their equivalents are intended to cover such forms or modifications as would fall within the scope and spirit of the inventions.

What is claimed is:

1. A display control apparatus comprising:
a memory configured to store first menu configuration information for a first menu screen and second menu configuration information for a second menu screen;
an output module configured to output first menu screen display information based on the first menu configuration information and content data in response to a selection of the first menu screen, and to output second menu screen display information based on the second menu configuration information and content data in response to a selection of the second menu screen; and
a setting module configured to set one of the first menu screen and the second menu screen as a top menu displayed at a start time,
wherein the first menu screen comprises playback application items for individually launching playback applications corresponding to content sources, and
the second menu screen comprises network application items for individually launching network applications corresponding to network services.

2. The apparatus of claim 1, wherein the first menu screen comprises the playback application items having different display sizes, and
the second menu screen comprises the network application items having a uniform display size.

3. The apparatus of claim 2, wherein the output module is configured to output the first menu screen display information to display an unselected playback application item in a first display size, and to display a selected playback application item in a second display size larger than the first display size.

4. The apparatus of claim 1, wherein the first menu screen comprises a first switching item for switching from the first menu screen to the second menu screen, and
the second menu screen comprises a second switching item for switching from the second menu screen to the first menu screen.

5. The apparatus of claim 1, wherein the network application items comprise advertisement information corresponding to data downloaded from an external server.

6. The apparatus of claim 1, wherein the memory is configured to store the first menu configuration information prepared in advance, and the second menu configuration information updated by data downloaded from an external server.

7. The apparatus of claim 1, wherein the memory is configured to store a previous selection of the first menu screen or the second menu screen, and
the output module is configured to output either one of the first menu screen display information and the second menu screen display information in correspondence with the previous selection stored in the memory.

8. A menu display method comprising:
outputting first menu screen display information to display a first menu screen based on first menu configuration information and content data in response to a selection of the first menu screen; and
outputting second menu screen display information to display a second menu screen based on second menu configuration information and content data in response to a selection of the second menu screen,
wherein the first menu screen comprises playback application items for individually launching playback applications corresponding to content sources, and
the second menu screen comprises network application items for individually launching network applications corresponding to network services.
